(19) United States
(12) Patent Application Publication
(10) Pub. No.: US 2011/0219399 A1
(43) Pub. Date: Sep. 8, 2011

(54) APPARATUS AND METHOD FOR REGISTERING AND THE SUBSEQUENT SELECTION OF USER SELECTED ADVERTISEMENT DURING PLAYBACK

(75) Inventors: Brant L. Candelore, San Diego, CA (US); Frederick J. Zustak, Poway, CA (US)

(73) Assignee: SONY CORPORATION, Tokyo (JP)

(21) Appl. No.: 12/718,628

(22) Filed: Mar. 5, 2010

(51) Int. Cl. H04N 7/10

(52) U.S. Cl. 725/34

(57) ABSTRACT

According to one embodiment of the invention, a method of registering, and perhaps substituting broadcast television advertisements for lesser, time intensive advertisements is described. The method comprises (i) receiving digital content including segments of a audiovisual program separated by at least one broadcast advertisement; (ii) detecting an operation that alters playback of the broadcast advertisement; (iii) in response to detecting the alters playback, retrieving a stored advertisement from a local memory storage unit, the stored advertisement being associated with a genre of advertisements selected by a user; and (iv) outputting for display the stored advertisement in lieu of the broadcast advertisement, the stored advertisement having a playback time less than a prescribed amount of a normal playback time of the broadcast advertisement. Other embodiments are described and claimed.

### FIELD

The invention is related to the field of content recordation. More specifically, certain embodiments of the invention are directed to a registration scheme for the selection and substitution of lesser, time intensive advertisements within incoming television signals for playback.

### BACKGROUND

Currently, television is widely used as a source of both information and entertainment. Cable and satellite systems broadcast tens or even hundreds of channels of programming. Given the large number of programs that are available to a viewer and are broadcast at prescribed times, in some situations, a viewer may be unable to watch all of the programs that he or she wishes to see. Consequently, over the last few decades, a number of electronic devices have been developed to record broadcast television signals.

For instance, video cassette recorders (VCRs) provide viewers with an ability to record incoming audiovisual programs on a magnetic tape and to subsequently view such programs. A timer in the VCR allows the user to record these audiovisual programs at their prescribed broadcasting time. Consequently, the recorded programs are available for playback at the user's convenience.

Thereafter, the basic concept of VCRs has been extended to a hard-drive or semiconductor based recording devices that is commonly referred to as Personal Video (or Versatile) Recorders (PVRs). Normally, a PVR is connected between a viewer's television and that viewer's cable box, satellite receiver or antenna. The PVR can control the channel tuned on the television, provide an interactive electronic program guide and record programs on a manual or timer-controlled basis.

The PVR can buffer incoming audiovisual programs so that the viewer can pause a “live” television program or replay a portion of a live television program without missing any subsequent segment of the program, as long as the pause or replay does not exceed the storage capacity of the PVR. Additionally, the PVR can be programmed to regularly record a user's favorite programs. Consequently, the PVR provides greater flexibility in recording and capturing incoming audiovisual signals than is available with a VCR.

Within broadcast television programs, advertisements (e.g. television commercials) are interspersed between segments of the audiovisual program and are broadcast as part of the television signal. These advertisements are an important source of revenue for the broadcaster and an important source for the advertiser in reaching current and potential customers with information related to products and services featured in the advertisement.

However, viewers often consider advertising as a nuisance since they normally want to watch a television program without interruption. Consequently, when a viewer has recorded the program using a PVR, the viewer will tend to fast-forward through the program during commercials or skip ahead. Usually there is no audio playback during a “fast-forward” or “skip” operation. Hence, while the audio is muted, the playback of images is accelerated to minimize the interruption in viewing the recorded program.

While such “fast-forwarding” and “skip” operations focus the viewing experience on the audiovisual (television) program, they are detrimental to both the advertiser who is trying to reach potential customers and the broadcaster who depends upon advertising for revenue. As a result, there is a need for a system and method that still allow a viewer who has recorded broadcast programs to minimize the interruption caused by interspersed advertisements, while also protecting the broadcaster's source of revenue.

### BRIEF DESCRIPTION OF THE DRAWINGS

The present invention is illustrated by way of example, and not by way of limitation, in the figures of the accompanying drawings and in which:

FIG. 1A is a first exemplary embodiment of a system implementing an advertisement selection unit within a digital device.

FIG. 1B is a second exemplary embodiment of a system implementing an advertisement selection unit within a digital device.

FIG. 1C is a second exemplary embodiment of a system implementing an advertisement selection unit within a digital device.

FIG. 2 is an exemplary embodiment of the digital device of FIG. 1C.

FIGS. 3A-3B are exemplary embodiments of the content stream format using an adaptation field of an I-frame for advertisement replacement.

FIGS. 3C-3D are exemplary embodiments of the content stream format using a secondary tagging scheme for advertisement replacement.

FIG. 4A is an exemplary embodiment of a user interface produced by the advertisement control unit of the digital device to commence registration of one or more viewers.

FIG. 4B is an exemplary embodiment of a user interface produced by the advertisement control unit of the digital device to program the preferred advertisements for a first viewer.

FIGS. 5A-5C are exemplary embodiments of the user interfaces produced by the advertisement control unit of the digital device to program the preferred genre for the advertisements.

FIGS. 6A-6B are exemplary embodiments of the user interfaces produced by the advertisement control unit of the digital device to program the preferred source of the advertisements.

FIG. 7 is an exemplary embodiment of the user interface produced by the advertisement control unit of the digital device to preclude certain genre of advertisements for particular viewers.

FIGS. 8A-8C are exemplary embodiments of user interfaces produced by the advertisement control unit of the digital device to provide preference ratings for the advertisements.

FIG. 9 is an exemplary embodiment of a user interface used to determine the current viewing audience.

### DETAILED DESCRIPTION

In the following description, for the purposes of explanation, numerous specific details are set forth in order to provide a thorough understanding of the present invention. The following description provides exemplary embodiments of the invention, and the accompanying drawings show these various exemplary embodiments for illustrative purposes. However, these examples should not be construed in a limiting sense as they are merely intended to provide exemplary embodiments of the invention rather than to provide an exhaustive list of all possible implementations. In other instances, well-known structures and devices are not shown in block diagram form in order to avoid obscuring the details of the invention.

In the following description, certain terminology is used to describe features of the invention. For instance, the term “digital device” may refer to consumer electronic equipment that is adapted to perform one or more of the following operations on transmissions from a content provider: tune, receive, decrypt, descramble and/or decode. Examples of consumer electronic equipment may include, but are not limited or restricted to a television, a set-top box, a personal digital assistant (PDA), a computer, a telephone that is cellular or wireless enabled, a video game console, a portable or stationary music player, a personal video recorder (PVR), or the like. Also, examples of a “content provider” include, but are not limited or restricted to a terrestrial broadcaster, a cable or satellite television distribution system, or a company providing content for download over the Internet or other Internet Protocol (IP) based networks like an Internet Service Provider (ISP).

Also, in certain situations, the terms “unit” and “logic” are representative of hardware, firmware and/or software configured to perform one or more functions. Examples of “hardware” include, but are not limited or restricted to an integrated circuit such as memory or a processor (e.g., a digital signal processor, microprocessor, application specific integrated circuit, a micro-controller, a type of programmable gate array, etc.). Of course, the hardware simply may be a collection of combinatorial logic.

An example of “software” includes executable code in the form of an application, an applet, a routine or even a series of instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, etc.), a hard drive disk, a flash drive, a floppy diskette, an optical disk (e.g., compact disk or digital video disc “DVD”), magnetic tape, or the like.

I. Exemplary System/Device Architecture

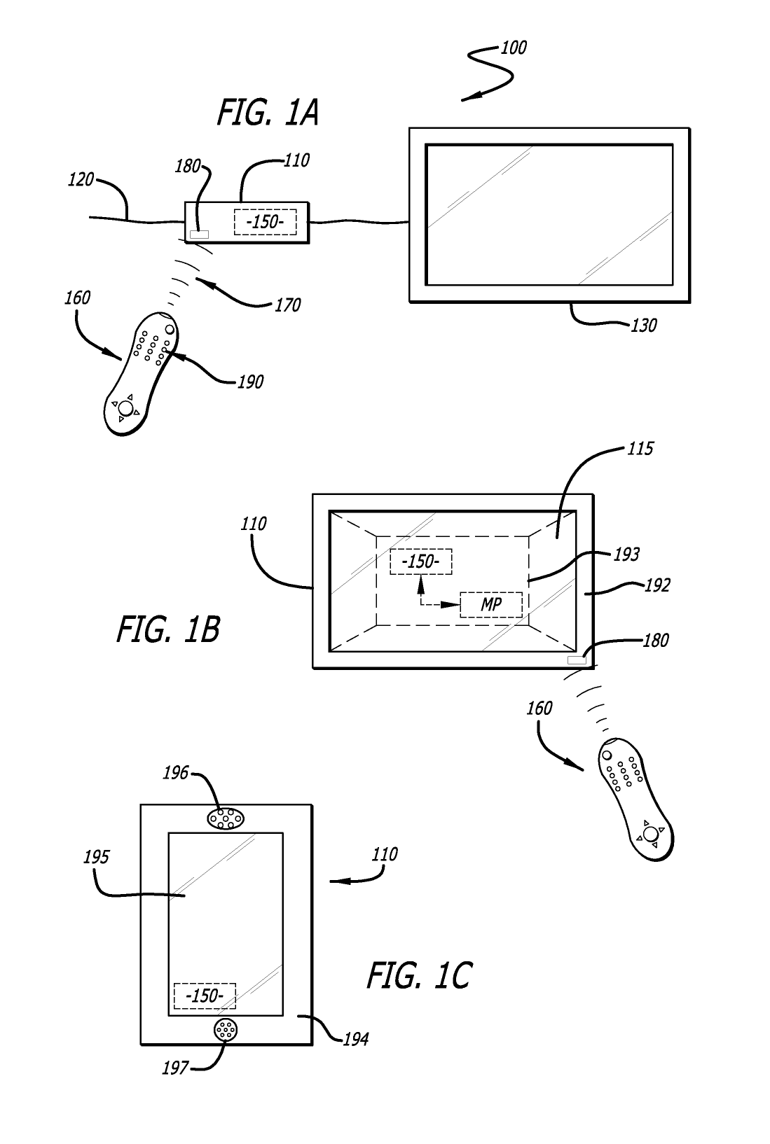

Referring to FIG. 1A, a first exemplary embodiment of a content delivery system 100 implementing an advertisement control unit within a digital device is shown. One purpose of content delivery system 100 is to deliver content from a content provider to a targeted destination. This targeted designation includes a digital device 110 (e.g., set-top box or PVR) that is in communication with the content provider over an input link 120 to receive digital content that includes advertisements (e.g., video and/or audio) interspersed between segments of an audiovisual program. The advertisements may be delivered in the same channel as the audiovisual program and even within the same data stream. Alternatively, of course, the advertisements may be delivered over a different channel from the audiovisual program.

According to this embodiment of the invention, digital device 110 is further coupled to a second digital device, such as a television 130 for example, that is adapted to display the content. Digital device 110 includes an advertisement control unit 150 that is adapted to identify, select and/or substitute advertisements geared toward a particular viewer of television 130.

Being a wireless controller that is remotely located from digital device 110, a remote 160 controls the operations of advertisement control unit 150. Remote 160 is adapted to communicate commands through a communication link 170 established between remote 160 and digital device 110. In particular, according to this embodiment of the invention, the communication link 170 is a wireless light emitting diode (LED) communication path through which remote 160 sends commands that are formed as light pulses. These light pulses are detected by a LED detector 180 located on digital device 110. Alternatively, link 170 may be radio-frequency signaling or wireless signaling of other bandwidths where detector 180 constitutes an RF detector.

As shown, a particular command from remote 160 may be produced by depressing buttons 190 accessible on an outer top surface of remote 160. Buttons 190 may include a power button, a key of a keypad designating numerals and/or characters, a select button with multidirectional arrows that provide scrolling as needed, or the like.

Referring now to FIG. 1B, a second exemplary embodiment of content delivery system 100 implementing advertisement control unit 150 within digital device 110 is shown. Herein, digital device 110 is a device with a display screen 115. Similar to FIG. 1A, detector 180 is implemented within a casing 192 of digital device 110, namely a flat paneled television. Detector 180 detects signals from remote 160 and transfers those signals (e.g. commands) to a processor (MP) located on a back cabinet 193 of television 110. Herein, the processor receives the commands and issues appropriate signaling to advertisement control unit 150 in order to provide information regarding the viewing audience and/or advertisement selections for substituting advertisements between segments of the audiovisual program as necessary.

Referring to FIG. 1C, a third exemplary embodiment of a system implementing advertisement control unit 150 within digital device 110 is shown. Herein, digital device 110 is portable with an integrated display, such as cellular telephone for example. Cellular telephone 110 includes a casing 194, a user interface 195 (e.g. touch screen, keypad, etc.), a speaker 196 and a microphone 197. Herein, advertisement control unit 150 may be hardware, firmware or software such as a downloadable application that is executed by a processor implemented within casing 194 of cellular telephone 110. For that embodiment of the invention, advertisement control unit 150 either can be (i) prestored within local memory of telephone 110 at manufacturer, (ii) stored prior to distribution to the user, or (iii) downloaded into local memory by the user initiating communications with a remote source such as an application server. These communications may be over a private or public network to an application server hosted by any of the following: the cellular telephone service provider, the telephone manufacturer/distributor, or a third party.

According to one embodiment of the invention, upon downloading advertisement control unit 150 into local memory of telephone 110, it operates in the background by monitoring and substituting advertisements associated with audiovisual programs played back on telephone 110. Of course, it is contemplated that advertisement control unit 150 may operate in the foreground in order to provide the user with greater control of the advertisement selection process.

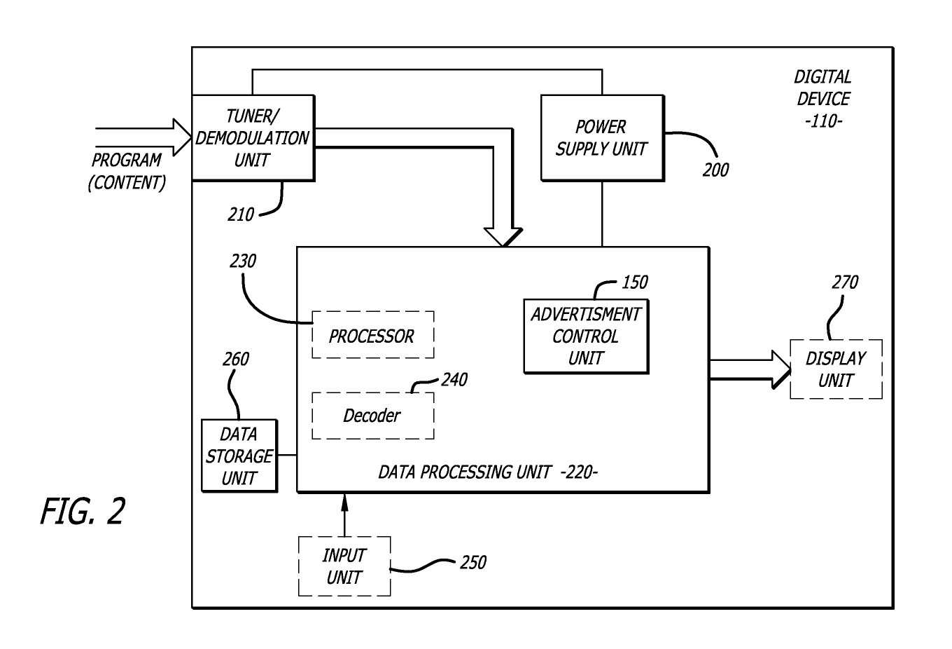

Referring now to FIG. 2, an exemplary diagram of an embodiment of digital device 110 of content delivery system 100 is shown. According to this embodiment of the invention, digital device 110 comprises a power supply unit 200, a tuner/demodulation unit 210 and data processing unit 220. Power supply unit 200 is adapted to provide power to tuner/demodulation unit 210 and data processing unit 220. Power supply unit 200 may provide regulated power based on input power received from a wall socket (e.g., 110 volts alternating current “VAC”, 220 VAC, etc.) or a battery. Tuner/demodulation unit 210 tunes to a channel to receive an incoming digital content and demodulates the content to recover the advertisements and the audiovisual program. The audiovisual program and the advertisements are routed as a digital bit stream to data processing unit 220.

According to one embodiment of the invention, data processing unit 220 comprises a processor 230 and/or a decoder 240. These components may be implemented as separate integrated circuits or as a single integrated circuit. As described herein, data processing unit 220 features logic operating to decode and process incoming information as well as advertisement control unit 150 that is adapted to alternatively select the genre and source of advertisements that are fetched/filtered and stored within digital device 110 for subsequent playback during viewing of the audiovisual program. An input unit 250 may be implemented as an integral part of digital device 110 or may be separate and remotely located from digital device 110 (not shown).

In general, according to one embodiment of the invention, advertisement control unit 150 is adapted to generate user interfaces for registration purposes and to replace broadcast advertisements with advertisements fetched from a data storage unit 260 that operates as local memory for digital device 110. The replacement scheme may involve tags within the broadcast program to identify what advertisements are to be fetched from data storage unit 260. Another replacement scheme may involve data processing unit 220 accessing metadata within an Adaptation field of one or more Motion Picture Experts Group (MPEG) packets associated with an advertisement in order to provide signaling to advertisement control unit 150 regarding the genre or subject matter of the advertisement. This metadata allows advertisement control unit 150 to determine whether the genre or subject matter of the advertisement is preferred by the viewer for playback on a display unit 270. Display unit 270 may be implemented as an integral part of digital device 110 or may be separate and remotely located therefrom (not shown).

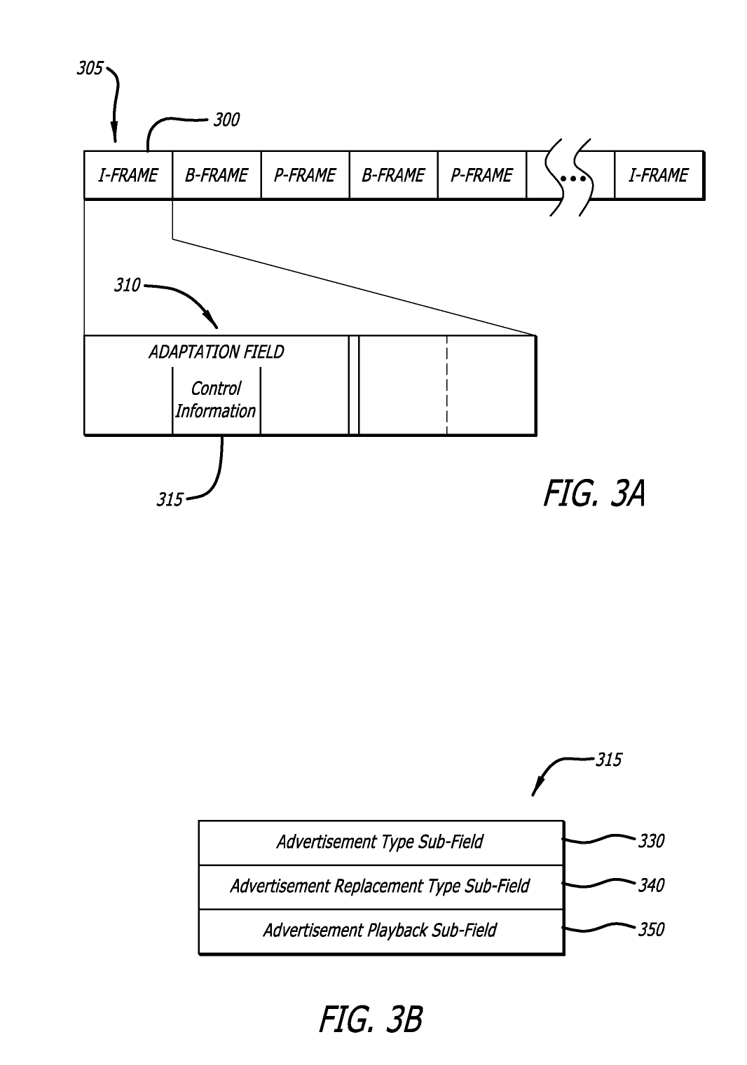

For instance, as shown in FIG. 3A, an exemplary diagram of an adaptation field 310 of an I-frame 300 is shown. Adaptation field 310 is a portion of a MPEG packet 305 of a digital data stream, where according to this embodiment, MPEG packet 305 is associated with an advertisement to be displayed. Adaptation header 310 features control information 315 to indicate (i) whether an advertisement playback feature is enabled, and/or (ii) the genre of the advertisement.

More specifically, according to this particular embodiment of the invention, adaptation header 310 comprises control information 315 that includes at least one bit to indicate whether the advertisement playback feature is enabled. This enables the digital device to operate in two or more modes, where at least one mode is designed to prevent fast-forwarding as well as skipping/pausing/muting of advertisements (e.g., advertisement playback feature). For instance, when control information 315 includes three bits, the digital device may operate in eight or less modes. Of course, more bits may be utilized to support a greater number of operating modes as shown in Table A where 5 bits (up to 32 modes) may be supported.

TABLE A

| Mode | Fast-Forwarding | Skip | Mute | Pause |
|---|---|---|---|---|
| 0 | Permitted at all rates > | Permit | Permit | Permit |
| | normal playback rate | | | |
| | (All FF) | | | |
| 1 | Permitted at all rates > | Prohibit | Permit | Permit |
| | normal playback rate | | | |
| | (All FF) | | | |
| 2 | Permitted at all rates > | Permit | Prohibit | Permit |
| | normal playback rate | | | |
| | (All FF) | | | |
| 3 | Permitted at all rates > | Permit | Permit | Prohibit |
| | normal playback rate | | | |
| | (All FF) | | | |
| 4 | Prohibited at rate ≧30 | Prohibit | Prohibit | Prohibit |
| | times normal playback | | | |
| | rate (30X FF) | | | |
| 5 | Prohibited at rates ≧16 | Prohibit | Prohibit | Prohibit |
| | times normal playback | | | |
| | rate (16X & 30X FF) | | | |
| 6 | Prohibited at rates ≧8 | Prohibit | Prohibit | Prohibit |
| | times normal playback | | | |
| | rate (8X, 16X & 30X FF) | | | |
| 7 | Prohibited at rates ≧2 | Prohibit | Prohibit | Prohibit |
| | times normal playback | | | |
| | rate (2X, 8X, 16X & 30X FF) | | | |
| 8-11 | Prohibited at selected | Permit | Prohibit | Prohibit |
| | rate ≧ normal playback | | | |
| | rate (2X, 8X, 16X & ≧30X FF) | | | |
| 12-15 | Prohibited at selected | Prohibit | Permit | Prohibit |
| | rate ≧ normal playback | | | |
| | rate (2X, 8X, 16X & ≧30X FF) | | | |
| 16-19 | Prohibited at selected | Prohibit | Prohibit | Permit |
| | rate ≧ normal playback | | | |
| | rate (2X, 8X, 16X & ≧30X FF) | | | |
| 20-23 | Prohibited at selected | Permit | Permit | Permit |
| | rate ≧ normal playback | | | |
| | rate (2X, 8X, 16X & ≧30X FF) | | | |

As set forth in FIG. 3B, control information 315 of adaptation header 310 comprises a plurality of sub-fields, including but not limited or restricted to one or more of the following: (1) advertisement type sub-field 330; (2) advertisement replacement type sub-field 340; and (3) advertisement playback sub-field 350.

Advertisement content type sub-field 330 identifies the genre of advertisement intended for display. This information may be used by advertisement control unit 150 of FIG. 2 to select various types of replacement advertisements, if advertisement replacement is supported.

Advertisement replacement type sub-field 340 identifies the type of replacement schemes that are available in response to detection of an accelerated playback of an advertisement (e.g., fast-forwarding and/or skipping) by the advertisement control unit. For instance, in response to a particular action to reduce the viewing time of the advertisement (e.g., ×30 FF or skip), the advertisement control unit may substitute the advertisement with a different full-length advertisement previously selected by the user. Alternatively, the advertisement control unit may cause the digital device to operate in an abbreviated mode in which a partial-length audiovisual advertisement(s) or an advertisement with static image(s) is substituted for the broadcast advertisement(s). These “abbreviated” advertisements have a display time that is less than the normal fifteen or thirty seconds allocated for broadcast advertisements.

Advertisement playback sub-field 350 identifies whether there are restrictions against altering of a broadcast advertisement (e.g., fast-forwarding, skipping, pausing, muting, etc.), and if so, to what degree are such alterations permitted as shown above in Table A.

Alternatively, it is contemplated that the control information may be placed in another location within the content stream other than the adaptation header 310 of FIG. 3A. For instance, as shown in FIG. 3C, the control information may be placed within a tag 360 that precedes one or more advertisements. Tag 360 includes information that (1) identifies the genre of advertisement intended for display; (2) identifies the type of replacement schemes that are available in response to detection of an accelerated playback of an advertisement; (3) identifies whether there are restrictions against altering of a broadcast advertisement (e.g., fast-forwarding up to “m×” or “n×” times playback speed where m,n>1, skipping, pausing, muting, etc.); or any combination thereof. For instance, if there are restrictions, the information further indicates what alterations are permitted. As an example, the advertisement may allow for 2× or 8× fast forwarding, but in response to a fast forwarding operation of 30× or more, a static advertisement is displayed for a few seconds.

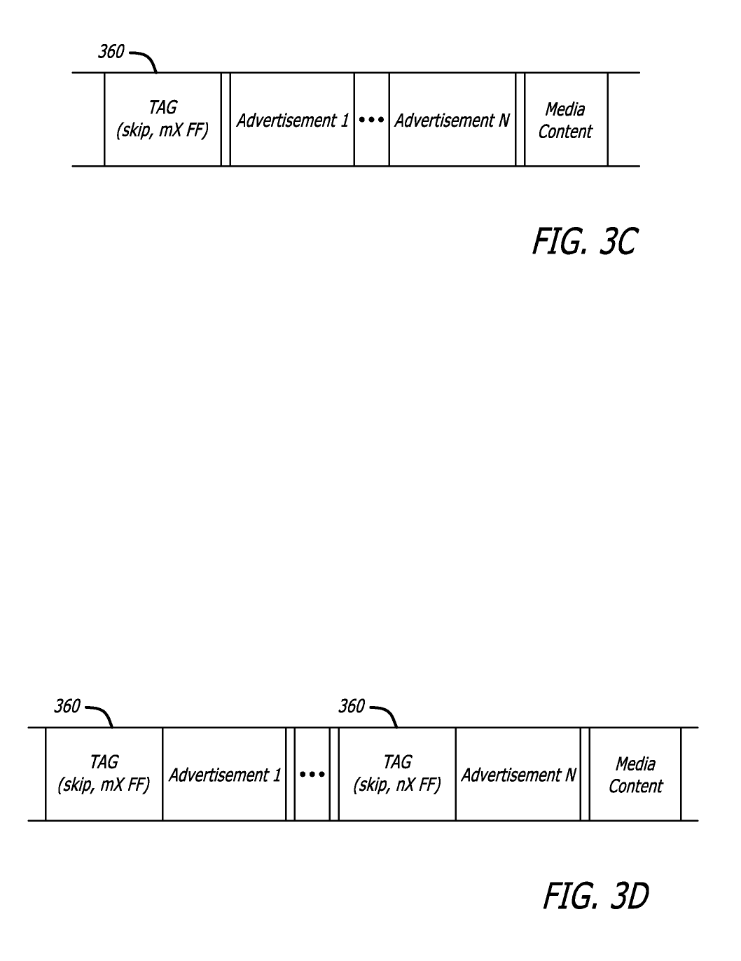

Referring to FIG. 4A, an exemplary embodiment of a user interface produced by advertisement control unit 150 of digital device 110 of FIG. 2 to commence registration of one or more viewers is shown. Herein, a registration image 400 is displayed by digital device 110 in order to allow the viewer or viewers to provide personal information. Herein, a viewer can use a remote or keypad associated with digital device 110 in order to enter alphanumeric characters that will provide some or all of the following information concerning the viewer(s): (1) name 410; (2) age 415; (3) gender 420; (4) ethnicity 425; and (5) income level 430.

For some of the viewer-based information, pull-down menus may be provided to allow the viewer to select the appropriate entry. For instance, as shown, a pull-down menu 440 may be provided with two entry selections: male “M” and female “F”. Additionally, pull-down menus may be provided for some of the other categories such as age, ethnicity, and income level. The “name” category however will most likely be input by the viewer via buttons on a remote or those associated with a digital device or an input mechanism integrated on digital device 110 such as a keypad, a touch screen, or the like.

Referring now to FIG. 4B, an exemplary embodiment of a user interface 450 produced by the advertisement control unit of the digital device to program the preferred advertisements for a first viewer is shown. Herein, user interface 450 provides a plurality of parameters for use in selecting preferred advertisements. For instance, as an example, these parameters include, but are not limited or restricted to a genre parameter 460, a source parameter 470 and a parental control parameter 480.

Genre parameter 460 is used to identify particular types of advertisements that the viewer would like to see interspersed between television programming. Source parameter 470 provides information from where the digital device is to fetch the advertisements. Parental control parameter 480 provides a mechanism to exclude certain types of advertisements from being displayed on the digital device. For instance, the parental controls may be viewer specific to exclude the displaying of a type of advertisement when a particular viewer is watching or may be generally applied to excluding this type of advertisement from being displayed on the digital device.

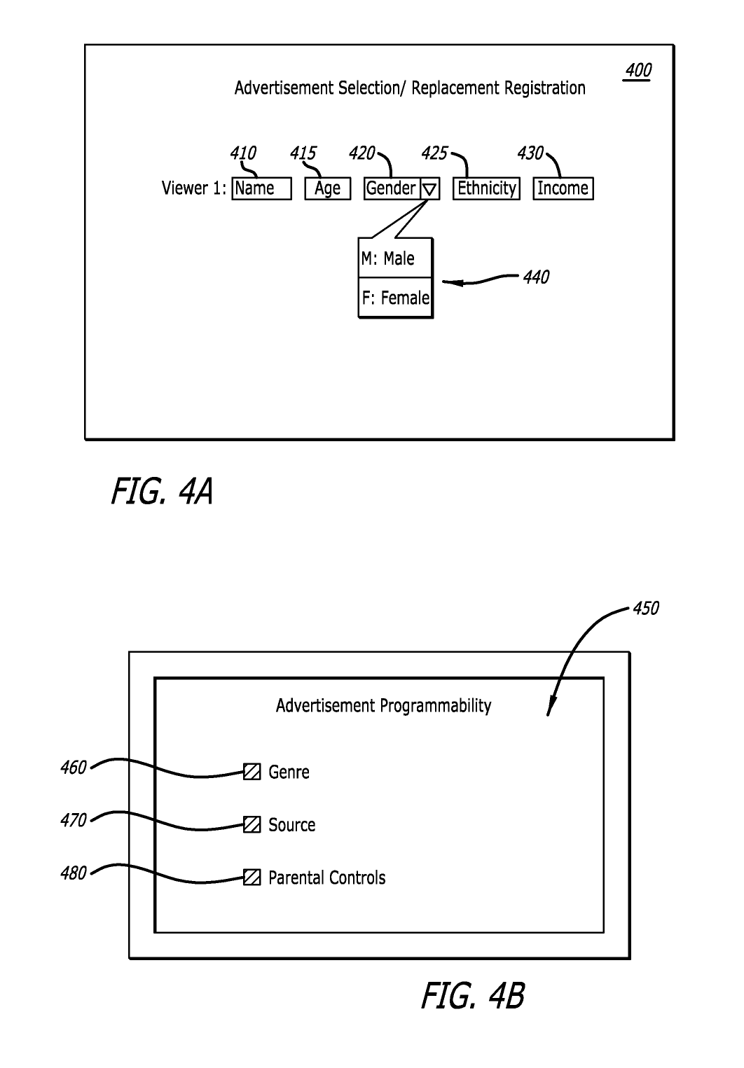

Referring now to FIGS. 5A-5C, exemplary embodiments of selectable user interfaces produced by the advertisement control unit of the digital device in order to program the preferred genre of the advertisements is shown. Herein, FIG. 5A illustrates a first user interface 500 of advertisement genre that is selectable by the viewer. According to this embodiment of the invention, the advertisement genre includes, but is not limited or restricted to financials 502, sports 504, beverages 506, electronics 508, automotive 510, fashion 512, furniture 514, health 516 and other 518. Herein, the viewer selects the genre of advertisements that he or she would be willing to watch in full or in an abbreviated mode in order to customize the advertisement viewing for that particular user.

According to one embodiment of the invention, at least one genre is required to be selected before proceeding to the next user interface of the advertisement selection scheme. Herein, the beverage and automotive categories 506 and 510 are selected by the viewer. In event that the “other” category 518 is selected, another selectable user interface (e.g., screen display) with additional advertisement genres is displayed for the viewer to choose different categories for this particular genre.

Of course, in lieu of selecting the particular genres that are acceptable to the viewer, interface 500 may be adapted so that all of the genre categories are selected. Now, the viewer would need to deselect the particular genre category or categories that he or she does not want to view.

Referring to FIG. 5B, a second user interface 530 is provided which provides greater granularity as the particular types of automotive advertisements that would be available to the viewer. Herein, according to one embodiment of the invention, the automotive advertisements are categorized according to the make of a particular type of automotive vehicle such as, for example, Lexus® 532, Acura® 534, Ford® 536, BMW® 538, Volvo® 540, Cadillac® 542, Honda® 544, Subaru® 546 and Other 548. According to another embodiment for this user interface, the automotive advertisements may be categorized according to make/model of these automotive vehicles.

In the event that the viewer selects one of the “make” categories illustrated in FIG. 5B, such as the Lexus® category for example, an additional user interface 550 is provided as shown in FIG. 5C. Of course, user interface 550 may be produced automatically or in response to selection of an entry (not shown). As shown, for this embodiment of the invention, user interface 550 is a selectable screen display that allows the user to select the particular “model” of the vehicle for which advertisements will be played back for the viewer. For this illustrative example, Lexus® LS460 and Lexus® ES350 sedans are selected.

If none of the vehicle models are selected, all Lexus® models will be selected by default in order to comply with the viewer's request for Lexus® advertisements in user interface 530 of FIG. 5B. Similarly, for the automotive “makes” set forth in FIG. 5B, in the event that none of these are selected by the viewer, the advertisement control unit enters into a default state where all automotive makes are selected in order to comply with the viewer's request for automotive advertisements in user interface 500 of FIG. 5A.

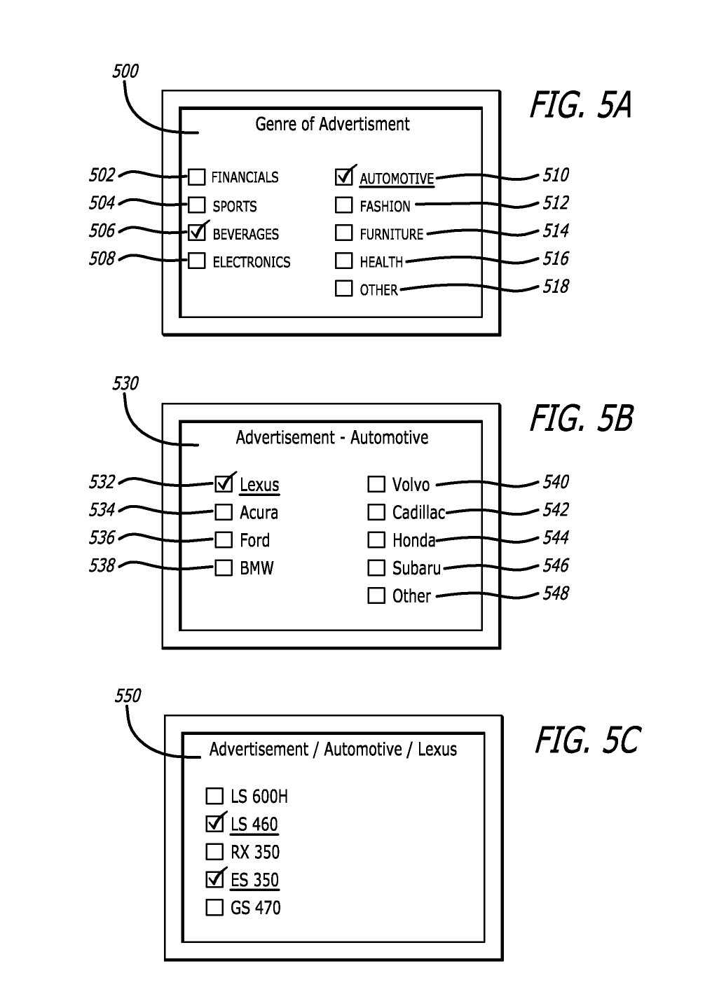

Referring now to FIGS. 6A and 6B, user interfaces 600 and 630 are shown in order to allow the viewer to select the particular source upon which the advertisements may be extracted. As shown in FIG. 6A, user interface 600 displays the sources from which advertisements can be recovered or obtained. These sources may include, but are not limited or restricted to a particular content provider 610 or various websites accessible over the Internet 620. Upon selecting advertisements from the content provider, advertisements periodically may be uploaded to the digital device therefrom and stored in local memory for subsequent retrieval. The periodicity of the uploading may be on a daily basis or with greater periodicity such as on an hourly basis.

Upon selecting the Internet parameter, a user interface 630 is generated, which is illustrated as a screen display that lists websites 640 and 645 from which the advertisements may be downloaded. These websites 640 and 645 may be dedicated websites for particular advertisers or websites of particular content providers or broadcasters. Alternatively, the websites may be a video based website from which revenue could be realized by the broadcasters from advertisements extracted from that particular website.

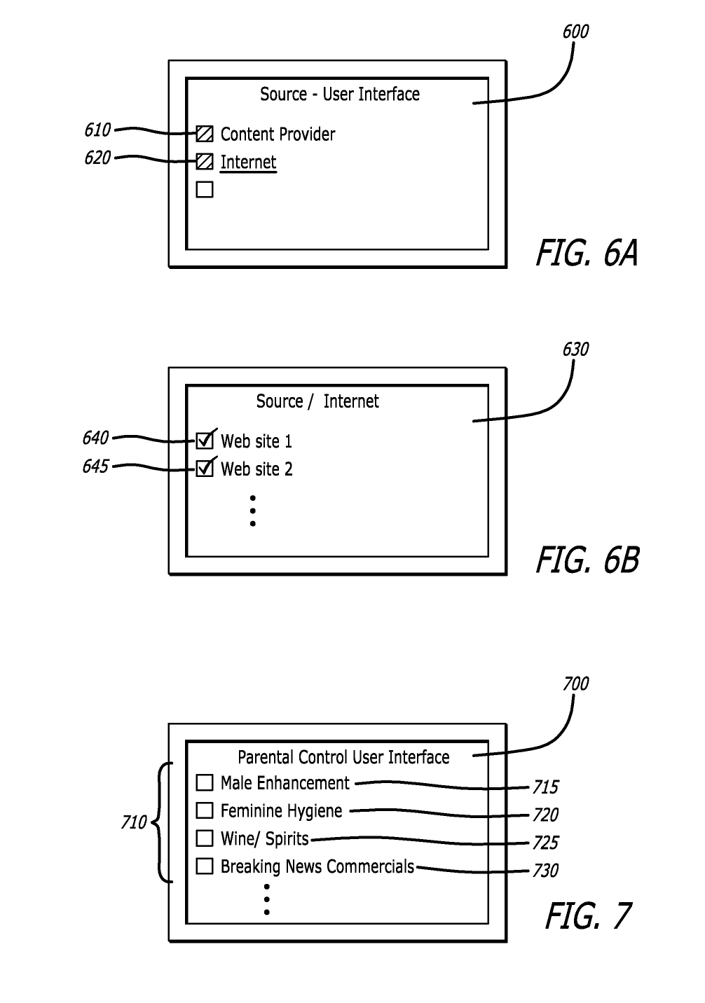

Referring to FIG. 7, an exemplary embodiment of the parental control user interface 700 is shown. Herein, various adult-oriented genres 710 are listed to enable a guardian of the viewer to select particular genres or advertisement categories that the viewer should not be allowed to view. For instance, such categories may include, for example, male enhancements 715, feminine hygiene products 720, wine & spirits 725, breaking news commercials 730 which are normally geared toward sensationalism, and the like. By selecting any of “parental control” genre, the advertisement control unit prevents such genre from being displayed.

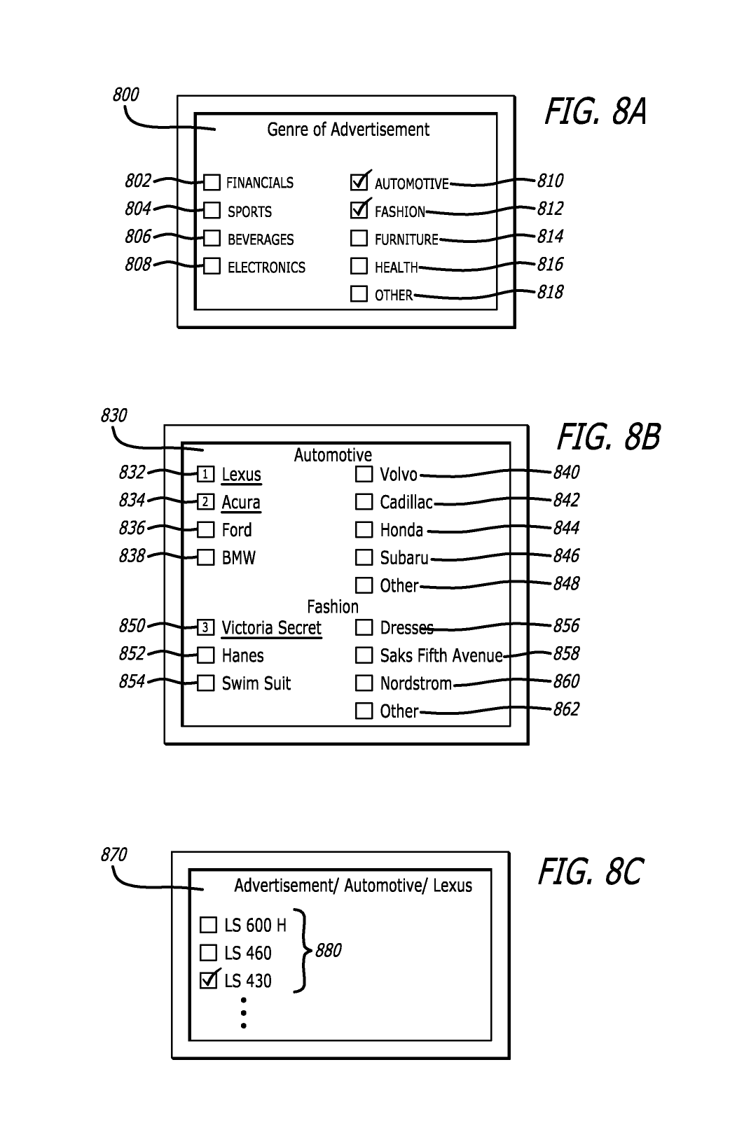

Referring now to FIGS. 8A-8C, exemplary embodiments of selectable user interfaces produced by the advertisement control unit of the digital device in order to program the preferred genre of the advertisements according to a rating scheme is shown. Herein, FIG. 8A illustrates a first user interface 800 of advertisement genre that is selectable by the viewer. According to this embodiment invention, the advertisement genre includes, but is not limited or restricted to financials 802, sports 804, beverages 806, electronics 808, automotive 810, fashion 812, furniture 814, health 816 and other 818. Herein, the viewer selects the genre of advertisements that he or she would be willing to watch in full or abbreviated mode in order to customize the advertisement viewing for that particular user.

According to one embodiment of the invention, at least one genre is required to be selected before proceeding to the next segment of the advertisement selection scheme. Herein, the automotive and fashion categories 810 and 812 are selected by the viewer. As previously described, in event that an “other” category 818 is selected, another user interface (e.g., screen display) with additional advertisement genres is displayed for the viewer to select different categories for this particular genre. Alternatively, in lieu of selecting the particular genres that are acceptable to the viewer, user interface 800 may be adapted so that all of the genre categories are selected. Now, the viewer would need to deselect the particular genre category or categories that he or she does not want to view.

Referring to FIG. 8B, a second user interface 830 is provided which provides greater granularity as to the particular types of automotive and fashion advertisements that are acceptable to the viewer. Herein, according to one embodiment of the invention, the automotive advertisements are categorized according to the make of a particular type of automotive vehicle such as, for example, Lexus® 832, Acura® 834, Ford® 836, BMW® 838, Volvo® 840, Cadillac® 842, Honda® 844, Subaru® 846 and Other 848. The fashion advertisements are categorized according to clothing maker, clothing type and/or store such as Victoria Secret® 850, Hanes® 852, swimsuit 854, dresses 856, Saks Fifth Avenue 858, Nordstrom 860, and other 862.

Instead of selecting the categories, the viewer can use the remote or input unit to provide preference ratings for each of these categories. For instance, according to this example, Lexus® and Acura® advertisements are rated “1” and “2” by depressing a corresponding numeral on the keypad of the remote while Victoria Secret advertisements was rated “3”. Further granularity of advertisements may be provided as described above, where each category provides sub-categories for the user to select.

As shown in FIG. 8C, for this embodiment of the invention, user interface 870 is a selectable screen display that allows the user to select the particular “model” 880 of the vehicle for which advertisements will be played back for the viewer. If none of the vehicle models are selected, all Lexus® models will be selected by default in order to comply with the viewer's request for Lexus® advertisements in user interface 830 of FIG. 8B.

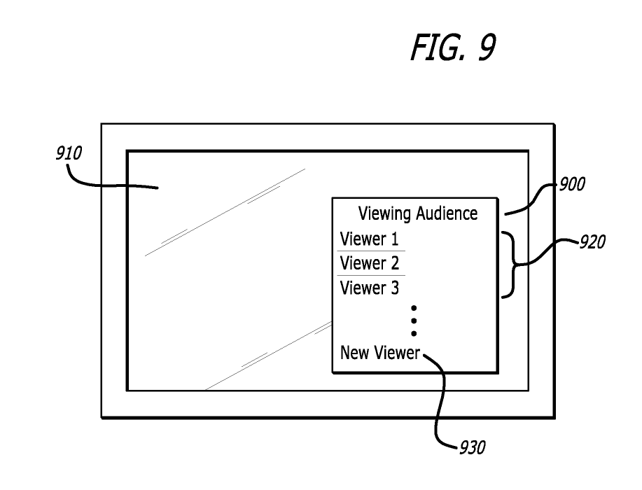

Referring to FIG. 9, after a viewer has registered his or her advertisement preferences, the advertisement control unit provides a control panel that identifies which registered viewer(s) is(are) currently watching the program. According to this embodiment of the invention, a control panel 900 is superimposed over an audiovisual program 910 that is being watched. Control panel 900 is used to determine the current viewing audience in order to provide appropriate controls signals to the advertisement control unit for advertisement selection.

Herein, control panel 900 includes one or more selectable entries 920 that are each associated with a registered viewer and designate which of the registered viewers form the viewing audience. An additional entry 930, when selected, begins registration of a new viewer. Upon selection of an entry associated with a registered viewer, the advertisement control unit is provided information that the registered viewer is part of the viewing audience. Hence, the advertisements will be tailored to the viewing audience. Control panel 900 may be displayed at initial power-on of the digital device and may be intermittently displayed automatically or in response to commands initiated by the viewer via the remote or a panel located on the digital device itself.

In the event that the viewing audience is identified as consisting of multiple registered viewers, the advertisement control unit determines if there is a subset of advertisements that are preferred by the entire viewing audience. In the event that the viewers substantially differ in advertisement preferences, and thus no subset can be computed, the advertisement control unit selects those advertisements that are preferred by any of the registered users. The advertisements may be pseudo-randomly selected or may be selected according to a particular pattern. For instance, the advertisements may be intermixed so that the first advertisement is of a genre preferred by the first viewer while the second advertisement is of a genre preferred by the second viewer, and the like.

If parental controls are in place for at least one of the viewers or for the digital device in general, the genre of advertisements that have been disallowed from viewing will not be shown, even if one of the viewers has such advertisements as part of his or her preferences. Besides mere selection of entries by the viewers, passwords may be required where parental controls are in effect.

Control panel 900 may also be used to remove a registered viewer from the viewing audience by deselecting the viewer who now will not be part of the viewing audience. As an example, this would remove a designation (e.g. underline, highlight, etc.) from the viewer's listed name. As a result, the advertisements may be specifically tailored to the remaining viewer(s).

Of course in lieu of viewer registration, it is contemplated that the registration process could be directed toward a category of users such as “adults” and “minors” for instance. In this situation, the viewer can be tailored to a broad category of viewers.

Having disclosed exemplary embodiments and the best mode, modifications and variations may be made to the disclosed embodiments while remaining within the scope of the embodiments of the invention as defined by the following claims.

What is claimed is:

1. An apparatus comprising:
a data storage unit adapted to store a plurality of advertisements corresponding to one or more genre selected by a user during an initial registration process; and
a data processing unit coupled to the data storage unit, the data processing unit being adapted to retrieve at least one of the stored advertisements upon detecting a user-based operation that alters playback of an advertisement that is part of broadcast television signal and is determined that the user-based operation is permitted to alter the playback of the advertisement.

2. The apparatus of claim 1 further comprising a display unit coupled to the data processing unit.

3. The apparatus of claim 2 being a portable cellular telephone with the data storage unit and the data processing unit encased within a casing and the display unit integrated as part of the casing.

4. The apparatus of claim 2 being a television including a detection unit to receive a command from a remote source and to output a signal associated with the command to the data processing unit located within a back cabinet of the television situated behind the display unit.

5. The apparatus of claim 1 being a set-top box that receives the broadcast television signal including an audiovisual program and a plurality of advertisements interspersed between segments of the audiovisual program and substitutes one of the plurality of advertisements with the at least one of the stored advertisements in response to the data processing unit detecting the user-based operation being conducted on the one of the plurality of advertisements.

6. The apparatus of claim 1, wherein data processing unit is adapted to detect the user-based operation being a fast-forwarding operation and to output for display the at least one of the stored advertisements only when the fast-forwarding operation involves a playback speed that is at least eight times greater than normal playback speed during viewing.

7. The apparatus of claim 1, wherein the user-based operation includes a skip operation that skips ahead a predetermine amount of the advertisement.

8. The apparatus of claim 6, wherein, prior to or upon detecting the fast-forwarding operation, the data processing unit analyzes control information within a packet partially forming the advertisement that is part of broadcast television signal to determine if the data processing unit is permitted to substitute the advertisement with the at least one of the stored advertisements.

9. The apparatus of claim 8, wherein the data processing unit accesses a portion of the control information to select the stored advertisement as a substitute for the one of the plurality of advertisements.

10. The apparatus of claim 9, wherein the data processing unit accesses the portion of the control information being information identifying a genre of the one of the plurality of advertisements and selecting the advertisement corresponding to the genre of the one of the plurality of advertisements.

11. An apparatus comprising:
a tuner/demodulation unit adapted to receive digital content;
a data storage unit adapted to store a plurality of advertisements corresponding to one or more genre selected by a user; and
a data processing unit coupled to the tuner/demodulation unit and the data storage unit, the data processing unit being adapted to detect an operation that accelerates playback of an advertisement being part of the digital content, determine that the operation is permitted to alter the playback of the advertisement, and in response to detecting the accelerated playback and determining that altering of the advertisement is permitted, to retrieve a stored advertisement from the data storage unit and to output for display the stored advertisement, the stored advertisement having a playback time less than a normal playback time of the advertisement.

12. The apparatus of claim 11, wherein data processing unit to detect a fast-forwarding operation being the accelerated playback.

13. The apparatus of claim 11, wherein the data processing unit to detect the accelerated playback being a fast-forwarding operation that results in a playback time less than one-eighth of a normal playback time of the advertisement being part of the digital content.

14. The apparatus of claim 11, wherein the data processing unit to detect the accelerated playback being a skip operation.

15. A method comprising:
receiving digital content including segments of an audiovisual program separated by at least one broadcast advertisement;
detecting an operation that alters playback of the broadcast advertisement;
determining that the operation is permitted to alter the playback of the broadcast advertisement;
in response to detecting the operation that alters playback and determining that the operation is permitted to alter the playback, retrieving a stored advertisement from a local memory storage unit, the stored advertisement being associated with a genre of advertisements selected by a user during an initial registration process; and
outputting for display the stored advertisement in lieu of the broadcast advertisement, the stored advertisement having a playback time less than one-third of a normal playback time of the broadcast advertisement.

16. The method of claim 15, wherein determining that the operation is permitted to alter playback comprises detecting a fast-forwarding operation and to output for display the stored advertisement only when the fast-forwarding operation is at least eight times (8×) playback speed.

17. The method of claim 15, wherein determining that the operation is permitted to alter playback comprises detecting an operation that accelerates playback including a fast-forwarding operation exceeding playback speed by a particular multiple that varies between advertisements.

18. The method of claim 15, wherein determining that the operation is permitted to alter playback comprises detecting a skip operation.

19. The method of claim 15, wherein determining that the operation is permitted to alter comprises detecting a mute or pause operation.

20. The method of claim 15, wherein the outputting for display of the stored advertisement in lieu of the broadcast advertisement occurs for a time period greater than or equal to one-tenth of the normal playback time of the broadcast advertisement.
